(19) United States
(12) Patent Application Publication
(10) Pub. No.: US 2007/0052388 A1
(43) Pub. Date: Mar. 8, 2007

(54) Recharging rolling laptop bag

(76) Inventors: John W. Wilson, Phoenix, AZ (US); Jason W. Swanson, Phoenix, AZ (US)

Correspondence Address: JACKSON WALKER LLP, 901 MAIN STREET, SUITE 6000, DALLAS, TX, 75202-3797, US

(21) Appl. No.: 11/204,807

(22) Filed: Aug. 16, 2005

(51) Int. Cl. H02J 7/00

(52) U.S. Cl. 320/114

(57) ABSTRACT

A roller bag having integral thereto a battery and a small alternator geared to recharge the battery when the wheels of the roller bag are rotated. During times of commuting, such as within an airport terminal, between a terminal and a rental car facility, or in route to a hotel, the battery will remained charged and available to the mobile user to provide a reliable source of power. A power terminal is further integrated into the bag providing external access to the battery, which power terminals permit connection to portable electronic devices, and may include retractable cords and programming tips.

### FIELD OF THE INVENTION

The present invention is generally related to accessories for portable electronic devices including power converters, notebook traveling bags, and other such devices usable with portable electronic devices including notebook computers, MP3 players, cellular phones, portable gaming devices, digital cameras and so forth.

### BACKGROUND OF THE INVENTION

The traveling road warrior typically owns a host of accessories for their portable electronic devices to make traveling easier and more convenient. For instance, notebook computer bags, AC and DC input power converters, extra batteries, retractable cords and so forth are just some devices utilized to make operation of such devices possible when away from the office and during travel.

Power converters are typically utilized to provide power to portable electronic devices to facilitate the operation and/or recharging thereof. DC power, such as available from vehicles including cars and airplanes, and AC power available from wall sources, are typically utilized by the power converter to power the portable electronic devices to avoid the depletion of battery and/or charge the batteries during use or when not in use. Unfortunately, auxiliary power is not always available, and sometimes there is no time to charge such devices inbetween travel, such as when traveling through the airport terminal to terminal, from the terminal to a rental car facility, and so forth. Hence, the traveling user often carries additional power sources, including additional batteries, during these time periods.

There is desired an improved accessory adapted to provide power to portable electronic devices in such situations, which accessory is convenient and affordable.

### SUMMARY OF INVENTION

The present invention achieves technical advantages as a roller bag having integral thereto a battery and a charger geared to recharge the battery when the wheels of the roller bag are rotated. During times of commuting, such as within an airport terminal, between a terminal and a rental car facility, or in route to a hotel, the battery remains charged and available to the mobile user to provide a reliable source of power. At least one power terminal is further integrated into the bag providing external access to the battery, which power terminals are available to connect power cords for portable electronic devices. A universal power solution is achieved through utilization of a programming device, such as programming smart tips.

### BRIEF DESCRIPTION OF THE DRAWINGS

FIG. 1 is a perspective view of a roller bag according to one embodiment of the invention;

FIG. 2 is a diagram of an alternator disposed between a bag wheel and a bag battery; and

FIG. 3 is a diagram of a retractable cable which may be integrated into the bag and be usable with voltage programming tips.

### DETAILED DESCRIPTION OF THE PRESENT INVENTION

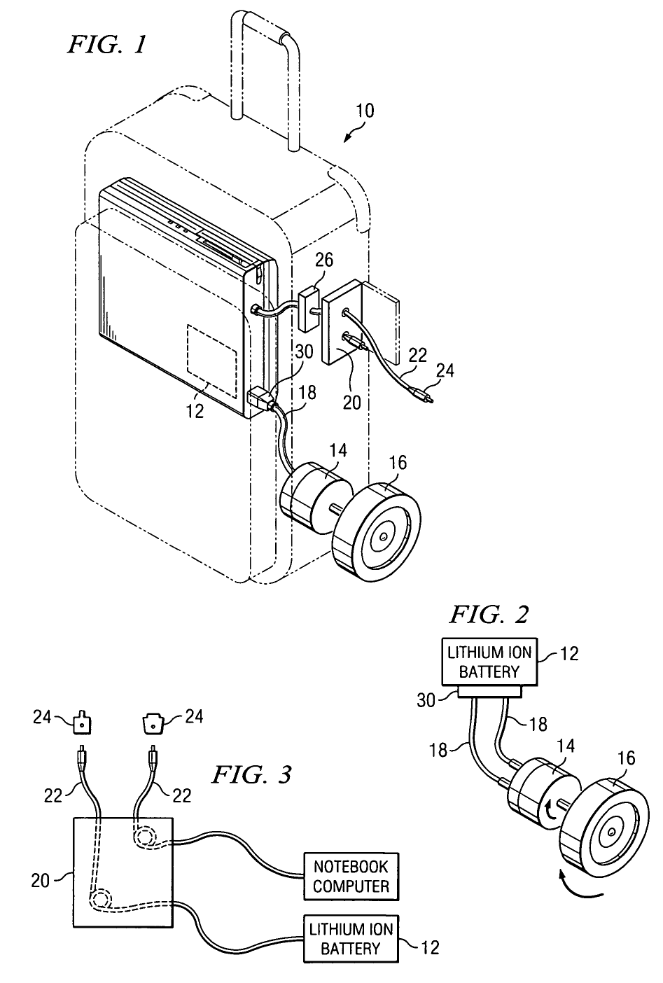

Referring to FIG. 1, there is shown a perspective view of a laptop roller bag at 10 having an integral battery 12 chargeable by a battery charger, shown as a generator 14, driven by wheels 16. Externally accessible connectors 20 are seen to be electrically coupled to battery 12, which provide access to power for charging and/or operating portable electronic devices via one or more cables 22. At a distal end of each cable 22 may be a detachable programming connector 24 adapted to mechanically interface to a variety of portable electronic devices, and further which connecters 24 program the output voltage and/or current to deliver power suitable to power a particular portable electronic device. Such inter changeable programming tips 24 may comprise of iTips™ manufactured and marketed by Mobility Electronics of Scottsdale, Ariz. Such programming connectors 24 program a power converter 26, which may be integral to battery 12 or interposed between battery 12 and connector 20 as shown, to deliver the appropriate power. Multiple connectors 20 are shown, each sourced with power from battery 12 so as to provide power to multiple portable electronic devices. Advantageously, the user has multiple power sources available via connectors 20, each which can be configured to provide a suitable voltage to a different respective portable electronic device. Each of cables 22 may further be individually retractable into the bag to provide further convenient accessibility of cables 22 and convenient storage thereof when not in use. The detachable tips 24 may be stored in a pocket or pouch integrated within bag 10, or disposed within a pocket of bag 10. A retractable handle 40 is also provided for convenient use thereof.

Still referring to FIG. 1, there is shown alternator 14 electrically coupled via cable 18 and connector 30 to battery 12. Alternator 14 may be a DC alternator/mini-motor adapted to generate a suitable voltage and current to charge battery 12, such as an internal lithium ion battery, although other batteries are possible and limitation to a lithium ion battery is not to be inferred.

Referring now to Table 1 and Table 2 below, there is shown some basic battery charging calculations based on two and three 6.25 volt cell phone battery charging, respectively.

TABLE 1
Basic Battery Charging Calculation Based on the IBM X40 Battery

| 61.92 | 1 | 0.95 | 0.9 | 0.85 |
|---|---|---|---|---|
| Time to | 100% | 95% | 90% | 85% |
| Charge (min) | Efficiency | Efficiency | Efficiency | Efficiency |
| 60 | 61.92 | 65.016 | 68.112 | 71.208 |
| 55 | 67.54909091 | 70.92654545 | 74.304 | 77.68145455 |
| 50 | 74.304 | 78.0192 | 81.7344 | 85.4496 |
| 45 | 82.56 | 86.688 | 90.816 | 94.944 |
| 40 | 92.88 | 97.524 | 102.168 | 106.812 |
| 35 | 106.1485714 | 111.456 | 116.7634286 | 122.0708571 |
| 30 | 123.84 | 130.032 | 136.224 | 142.416 |
| 25 | 148.608 | 156.0384 | 163.4688 | 170.8992 |
| 20 | 185.76 | 195.048 | 204.336 | 213.624 |
| 15 | 247.68 | 260.064 | 272.448 | 284.832 |
| 10 | 371.52 | 390.096 | 408.672 | 427.248 |
| 5 | 743.04 | 780.192 | 817.344 | 854.496 |
| 1 | 3715.2 | 3900.96 | 4086.72 | 4272.48 |

TABLE 2
Basic Battery Charging Calculation Based on One 6.25 Cell Phone Battery

| 6.25 | 1 | 0.95 | 0.9 | 0.85 |
|---|---|---|---|---|
| Time to | 100% | 95% | 90% | 85% |
| Charge (min) | Efficiency | Efficiency | Efficiency | Efficiency |
| 60 | 6.25 | 6.5625 | 6.875 | 7.1875 |
| 55 | 6.818181818 | 7.159090909 | 7.5 | 7.840909091 |
| 50 | 7.5 | 7.875 | 8.25 | 8.625 |
| 45 | 8.333333333 | 8.75 | 9.166666687 | 9.583333333 |
| 40 | 9.375 | 9.84375 | 10.3125 | 10.78125 |
| 35 | 10.71428571 | 11.25 | 11.78571429 | 12.32142857 |
| 30 | 12.5 | 13.125 | 13.75 | 14.375 |
| 25 | 15 | 15.75 | 16.5 | 17.25 |
| 20 | 18.75 | 19.6875 | 20.625 | 21.5625 |
| 15 | 25 | 26.25 | 27.5 | 28.75 |
| 10 | 37.5 | 39.375 | 41.25 | 43.125 |
| 5 | 75 | 78.75 | 82.5 | 86.25 |
| 1 | 375 | 393.75 | 412.5 | 431.25 |

As shown in Table 1, there is calculated the time to charge in minutes to attain desired battery efficiency, based on the battery having 0 charge prior to charging. Such time to charge is based upon the alternator/mini-motor 14 providing a 4V voltage and a 2A current when rotated by wheels 16 having a 2¼″ diameter rotated at normal walking speed. As can be appreciated, a 100% efficiency can be achieved in approximately 60 minutes. Of course, the size of the battery, the size of the alternator, and the speed of rotation of same will determine the power generated available for recharging the battery.

In a further embodiment of the present invention, the notebook computer (not shown) disposed within the laptop bag 10 can be adapted to be directly charged from the alternator 14 if desired. Suitable wiring from the alternator 14 to a voltage regulator, and ultimately provided to the laptop computer, as shown in FIG. 3, provides for recharging of the notebook computer without the need to remove the notebook computer and connect same to the battery 12 via the cables 22.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A system, comprising:
a bag having wheels and adapted to receive and protect a portable electronic device;
a rechargeable battery disposed in the bag; and
a power converter providing an output and disposed in the bag, coupled between the battery and a connector accessible from outside the bag further including a charging device charging the battery upon rotation of at least one of the wheels.

2. The system as specified in claim 1 wherein the power converter output is adapted to power a portable electronic device.

3. The system as specified in claim 2 further comprising a connector adapted to selectively electronically connect the power converter to the portable electronic device.

4. The system as specified in claim 3 wherein the connector is adapted to establish a voltage of power converter output.

5. The system as specified in claim 4 wherein the connector selectively establishes a resistor in a feedback loop of the converter to establish the output voltage.

6. The system as specified in claim 5 wherein the connector has an electrical component establishing the resistor in the feedback loop.

7. The system as specified in claim 6 wherein the electrical component is a resistor.

8. The system as specified in claim 1 wherein the charging device comprises an alternator coupled to the wheels and adapted to recharge the battery as a function of rotation of at least one of the wheels.

9. The system as specified in claim 3 further comprising at least one cord disposed between the power converter and the connector.

10. The system as specified in claim 9 wherein the cord is retractable.

11. The system as specified in claim 10 wherein the cord is retractable into the bag.

12. The system as specified in claim 9 further comprising a plurality of the cords disposed between the power converter and a respective said connector.

13. The system as specified in claim 12 wherein the cord is retractable.

14. The system as specified in claim 13 wherein the cord is retractable into the bag.

15. The system as specified in claim 2 wherein the power converter output comprises a DC voltage.
